(19) United States
(12) Patent Application Publication
(10) Pub. No.: US 2014/0218003 A1
(43) Pub. Date: Aug. 7, 2014

(54) OUTPUT SETTING DEVICE OF CONSTANT CURRENT CIRCUIT

(71) Applicant: YAZAKI CORPORATION, Tokyo (JP)

(72) Inventors: Mitsuaki MORIMOTO, Susono-shi (JP); Eiichiro OISHI, Susono-shi (JP)

(73) Assignee: YAZAKI CORPORATION, Tokyo (JP)

(21) Appl. No.: 14/250,430

(22) Filed: Apr. 11, 2014

Related U.S. Application Data
(63) Continuation of application No. PCT/JP2012/075944, filed on Oct. 5, 2012.

(30) Foreign Application Priority Data
Oct. 14, 2011 (JP) 2011-226466

(51) Int. Cl. G05F 3/16

(52) U.S. Cl. CPC G05F 3/16
USPC 323/315

(57) ABSTRACT

An output setting device of a constant current circuit includes a reference current generation circuit and first to fourth current mirror circuit groups. The reference current generation circuit feeds a reference current. Each current mirror circuit group includes at least one current mirror circuit that feeds a current proportional to the reference current. One current mirror circuit group or two or more current mirror circuit groups connected in parallel to each other among the plurality of current mirror circuit groups are connected to a load to set a current to be supplied to the load.

### CROSS REFERENCE TO RELATED APPLICATION

This is a continuation application based on PCT application No. PCT/JP2012/075944 filed on Oct. 5, 2012, which claims the benefit of priority from Japanese Patent Application No.2011-226466 filed on Oct. 14, 2011, the entire contents of which are incorporated by reference herein.

### BACKGROUND OF THE INVENTION

1. Field of the Invention

The present invention relates to an output setting device capable of changing an output current of a constant current circuit to any current value.

2. Description of the Related Art

For example, a load such as an LED lamp or a relay coil mounted on a vehicle is activated by a constant current supplied from a constant current circuit. For an LED lamp, the current value when activated differs according to the type of an LED to use. For a relay coil, the current value when activated differs according to the resistance value of a relay coil to use. Accordingly, the output current of a constant current circuit needs to be appropriately changed according to a load.

Hence, for example, there is proposed an output setting circuit described in Patent Literature 1 (Japanese Patent Application Laid-Open Publication No. H05-259756). FIG. 1 is a circuit diagram illustrating the configuration of the output setting circuit described in Patent Literature 1. As illustrated in FIG. 1, the output setting circuit includes an EEPROM 101, a decoder 102, and a current generator 103. The output setting circuit generates a constant current I0 by feeding a current generated by the current generator 103 to a current mirror circuit 104. Moreover, since the current generator 103 has a current value circuit where a current value is multiplied by one, a current value circuit where a current value is multiplied by two, a current value circuit where a current value is multiplied by four and a current value circuit where a current value is multiplied by eight, provided therein, the current generator 103 is capable of setting a desired current value with a combination of these circuits.

However, the conventional example disclosed in Patent Literature 1 needs to provide circuits such as the EEPROM 101, the decoder 102 and the current generator 103, in order to generate a reference current, and therefore the whole device becomes expensive. Moreover, in order to change the output current value, a data write operation to the EEPROM is required, and therefore there is a problem that it takes a lot of time and efforts to change the current value.

### SUMMARY OF THE INVENTION

The present invention has been made in order to solve the conventional problem, and aims to provide an output setting device of a constant current circuit, which facilitates setting of a current value and in which the device configuration can be simplified.

According to a first aspect of the present invention, there is provided an output setting device of a constant current circuit that sets a current to be supplied to a load, the output setting device comprising: a reference current generator that feeds a reference current; and a plurality of current mirror circuit groups each having at least one current mirror circuit that feeds a current proportional to the reference current, wherein one current mirror circuit group or two or more current mirror circuit groups connected in parallel to each other among the plurality of current mirror circuit groups are connected to the load to set a current to be supplied to the load.

According to a second aspect of the present invention, the plurality of current mirror circuit groups outputs current values different from each other.

According to a third aspect of the present invention, the number of the current mirror circuit groups is k (“k” is a positive integer), and when the reference current is set to Iref, the i-th current mirror circuit group (“i” is a positive integer equal to or less than k) outputs a current value of 2⁽ⁱ⁻¹⁾·α·Iref.

According to a fourth aspect of the present invention, the output setting device of a constant current circuit further comprises a power supply terminal, a ground terminal, and a plurality of connection terminals, wherein each current mirror circuit group has a first major electrode and a second major electrode, wherein the reference current circuit has one end connected to the power supply terminal and the other end connected to the ground terminal, and wherein the first major electrode of the each current mirror circuit group is connected to the connection terminal, and the second major electrode of the each current mirror circuit group is connected to the ground terminal.

According to the first aspect of the present invention, a current value is set using the current mirror circuit groups each including at least one current mirror circuit, and therefore a desired current can be set with a simple operation, and the operability can be improved. Moreover, the device scale can be simplified.

According to the second aspect of the present invention, a plurality of current mirror circuit groups outputs current values different from each other, and therefore by appropriately selecting one or more current mirror circuit groups, a desired current value can be easily set.

According to the third aspect of the present invention, the output current values of a plurality of current mirror circuit groups are set to current values which are respectively generated by multiplying the reference current by one, two, four and eight, and therefore by appropriately selecting one or more current mirror circuit groups, a desired current value can be set in a wide range.

According to the fourth aspect of the present invention, a reference current generator and a plurality of current mirror circuit groups can be mounted on an integrated circuit having a power supply terminal, a ground terminal, and a plurality of connection terminals, and the value of a current to be supplied to a load can be set with a simple operation of selecting one or more connection terminals and connecting the same to the load.

### BRIEF DESCRIPTION OF THE DRAWINGS

FIG. 1 is a circuit diagram illustrating the configuration of a conventional output setting device of a constant current circuit.

FIG. 2 is a circuit diagram illustrating the configuration of an output setting device of a constant current circuit according to an exemplary embodiment of the present invention.

FIG. 3 is a circuit diagram illustrating a detailed configuration of a current mirror circuit group used for the output setting device of the constant current circuit according to the exemplary embodiment of the present invention.

FIG. 4 is an explanatory view illustrating a combination of setting of current values by the output setting device of the constant current circuit according to the exemplary embodiment of the present invention.

FIG. 5 is a circuit diagram illustrating an example, in which the output setting device of a constant current circuit is mounted on an integrated circuit, according to the embodiment of the present invention.

FIG. 6 is an explanatory view illustrating an example, in which a load with a constant current of 5 mA is connected to an output setting device of a constant current circuit according to a modified example of the present invention.

FIG. 7 is an explanatory view illustrating an example, in which a load with a constant current of 30 mA is connected to the output setting device of the constant current circuit according to the modified example of the present invention.

FIG. 8 is an explanatory view illustrating an example, in which a load with a constant current of 15 mA and a load with a constant current of 25 mA are connected to the output setting device of the constant current circuit according to the modified example of the present invention.

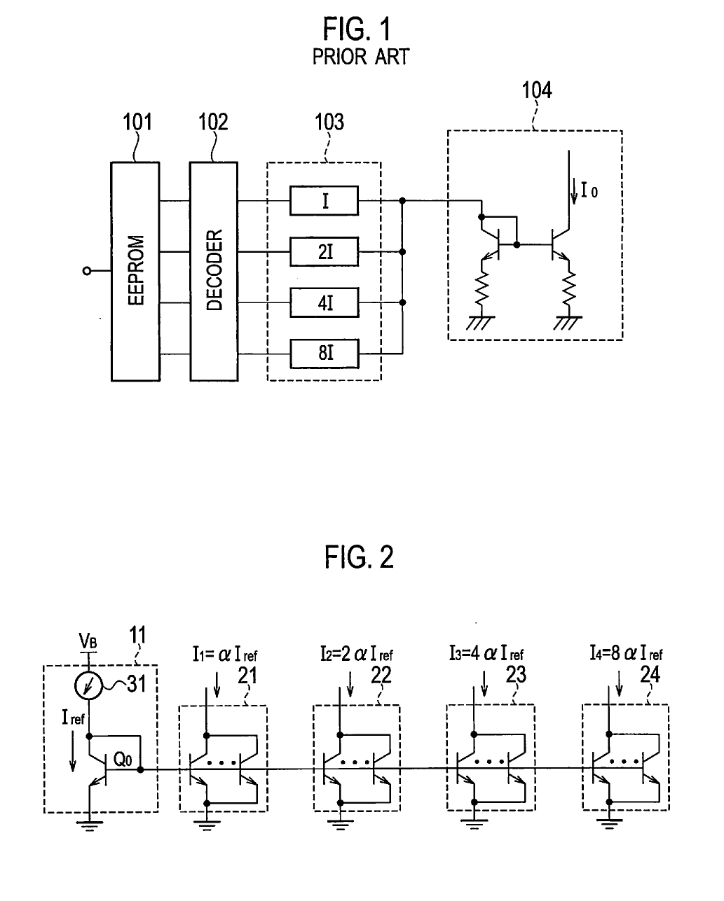

### DESCRIPTION OF THE EMBODIMENTS

Hereinafter, an exemplary embodiment of the present invention will be described in accordance with the accompanying drawings. FIG. 2 is a circuit diagram illustrating the configuration of an output setting device of a constant current circuit according to the exemplary embodiment of the present invention. As illustrated in FIG. 2, the output setting device includes a reference current generation circuit (reference current generator) 11 that feeds a reference current, a first current mirror circuit group 21, a second current mirror circuit group 22, a third current mirror circuit group 23 and a fourth current mirror circuit group 24.

The reference current generation circuit 11 includes a current source 31 that feeds a reference current Iref and a transistor Q0. A collector and a base of the transistor Q0 are shorted.

Each of the first to fourth current mirror circuit groups 21 to 24 includes at least one transistor forming a current mirror circuit with the reference current generation circuit 11. Each of the first to fourth current mirror circuit groups 21 to 24 is set so that a current proportional to the reference current Iref flows. Specifically, a current I1 flowing through the first current mirror circuit group 21 is set so as to be a current which has a value generated by multiplying the reference current Iref by α (α is a coefficient) (i.e., I1=α·Iref), and a current I2 flowing through the second current mirror circuit group 22 is set so as to be a current which has a value generated by multiplying the current I1 by two (i.e., I2=2α·Iref).

Moreover, a current I3 flowing through the third current mirror circuit group 23 is set so as to be a current which has a value generated by multiplying the current I1 by four (i.e., I3=4α·Iref), and a current I4 flowing through the fourth current mirror circuit group 24 is set so as to be a current which has a value generated by multiplying the current I1 by eight (i.e., I4=8α·Iref). That is, the k-th current mirror circuit group (k=1 to 4) is set so as to feed a current of 2^{(k-1)}·α·Iref.

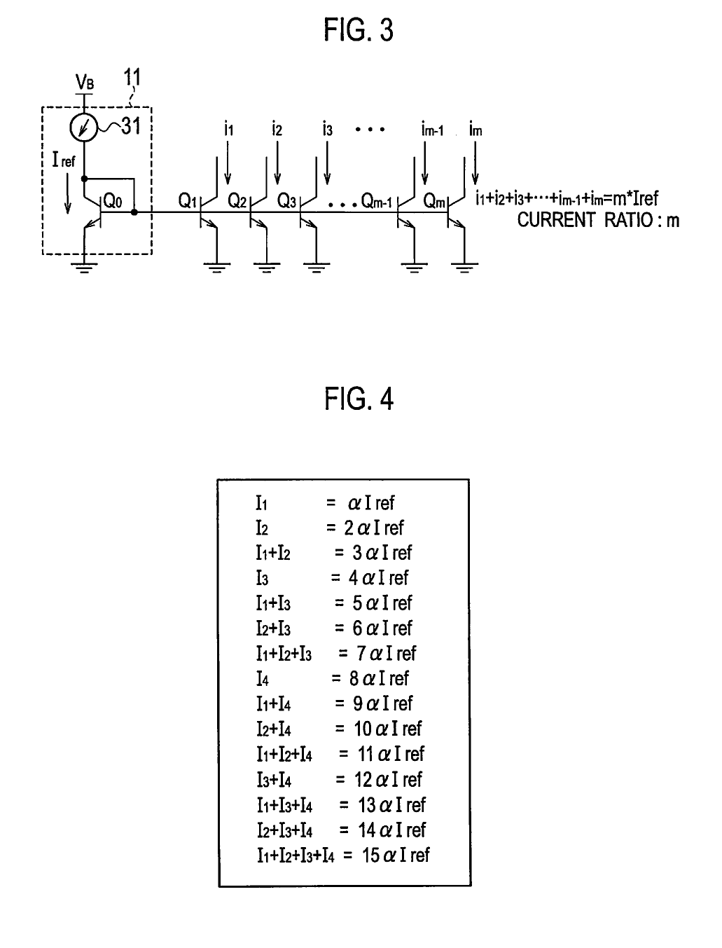

FIG. 3 is a circuit diagram illustrating the configuration of each of the first to fourth current mirror circuit groups 21 to 24. In each of the first to fourth current mirror circuit groups 21 to 24, a plurality of (m) transistors Q1 to Qm is connected in parallel with each other. The respective bases of the transistors Q1 to Qm are connected to the base of the transistor Q0 of the reference current generation circuit 11, and each of the transistors Q1 to Qm constitutes a current mirror circuit with the reference current generation circuit 11. Since each of the currents i1 to im flowing through the transistors Q1 to Qm is equal to the reference current Iref, a total current flowing through the current mirror circuit group is “m·Iref.” Accordingly, in the first to fourth current mirror circuit groups 21 to 24, currents, which have values respectively generated by multiplying the reference current Iref illustrated in FIG. 2 by a, 2a, 4a and 8a, can be set by changing the number of transistors.

Next, an effect of the output setting device of the constant current circuit constituted as described above will be described. Since relationships of “I1=α·Iref”, “I2=2α·Iref”, “I3=4α·Iref” and “I4=8α·Iref” are satisfied for the currents flowing through the current mirror circuit groups 21 to 24, any current can be set with a combination of these currents.

Specifically, when the value of a current to be supplied to a load (an LED lamp, a relay coil, or the like) is set to “α·Iref”, the first current mirror circuit group 21 may be connected to the load. When the current value is set to “2α·Iref”, the second current mirror circuit group 22 may be connected to the load. When the current value is set to “3α·Iref”, a parallel connection circuit of the first current mirror circuit group 21 and the second current mirror circuit group 22 may be connected to the load. In this manner, as illustrated in FIG. 4, the current value can be arbitrarily set in a range from “α·Iref” to “15α·Iref.”

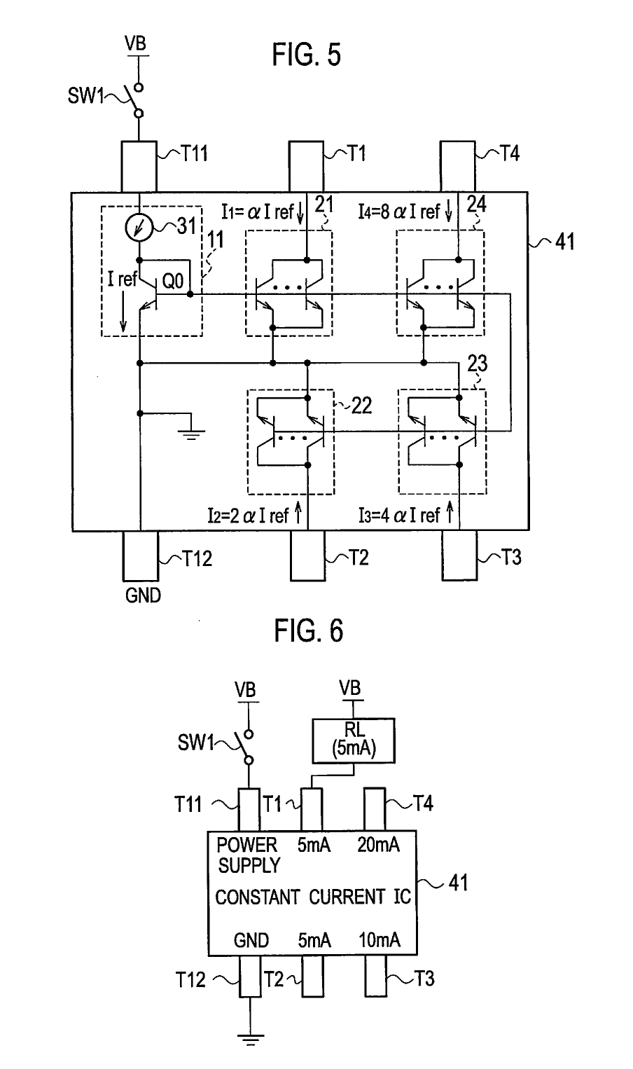

FIG. 5 is an explanatory view illustrating a configuration when the output setting device of the constant current circuit illustrated in FIG. 2 is mounted on an integrated circuit 41. As illustrated in FIG. 5, the integrated circuit 41 has four connection terminals T1 to T4, a power supply terminal T11 and a ground terminal T12. The current source 31 of the reference current generation circuit 11 is connected to the power supply terminal T11 and furthermore connected to a power supply VB via a switch SW1. An emitter of the transistor Q0 and emitters (the second major electrode) of the current mirror circuit groups 21 to 24 are connected to the ground terminal T12.

A collector (the first major electrode) of the first current mirror circuit group 21 is connected to the connection terminal T1. A collector of the second current mirror circuit group 22 is connected to the connection terminal T2. A collector of the third current mirror circuit group 23 is connected to the connection terminal T3. A collector of the fourth current mirror circuit group is connected to the connection terminal T4. The reference current generation circuit 11 and the first to fourth current mirror circuit groups 21 to 24 constitute one integrated circuit 41.

Accordingly, the power supply terminal T11 is connected to the power supply VB of a battery or the like of a vehicle, the ground terminal T12 is connected to a ground line, and one or more connection terminals among the connection terminals T1 to T4 are connected to a load such as an LED lamp or a relay coil, and thereby a current flowing through the load can be set to a desired current value using either one current mirror circuit group or two or more current mirror circuit groups connected in parallel with each other among the first to fourth current mirror circuit groups 21 to 24. That is, as illustrated in FIG. 4, the current value can be set within a range from αIref to 15αIref by selecting one or more connection terminals among the connection terminals T1 to T4.

In this manner, in the output setting device of the constant current circuit according to the present embodiment, a plurality of current mirror circuit groups (the first to fourth current mirror circuit groups 21 to 24, in the present embodiment) each having a different current value are provided, and a current value is set using either one current mirror circuit group or two or more current mirror circuit groups connected in parallel with each other among the first to fourth current mirror circuit groups 21 to 24, and therefore any current value can be set with a simple operation. Moreover, since there is no need to use expensive components such as an EEPROM, unlike the conventional output setting device, the configuration can be simplified and the device scale can be reduced.

Furthermore, the currents flowing through the current mirror circuit groups 21 to 24 are set so as to be currents which have values respectively generated by multiplying the reference current Iref by α, 2α, 4α and 8α (i.e. , the current value of the k-th current mirror circuit group is 2^{(k-1)}·α·Iref), and therefore with a combination of these, the current value can be set in a range from a times to 15α times the reference current Iref, thereby allowing the versatility to be expanded.

Next, a modified example of the output setting device of the constant current circuit according to the present embodiment will be described. FIGS. 6, 7 and 8 are the explanatory views illustrating an example in which a load is connected to an output setting device according to the modified example of the present embodiment. Note that, in FIGS. 6, 7 and 8, the integrated circuit 41 is denoted as a constant current IC. In the present modified example, the current values of the connection terminals T1 and T2 are set to 5 mA, the current value of the connection terminal T3 is set to 10 mA, and the current value of the connection terminal T4 is set to 20 mA.

This configuration is an example of the case where the output currents of the first and second current mirror circuit groups 21 and 22 are set to αIref, the output current of the third current mirror circuit group 23 is set to 2αIref, and the output current of the fourth current mirror circuit group 24 is set to 4αIref in the circuit illustrated in FIG. 2.

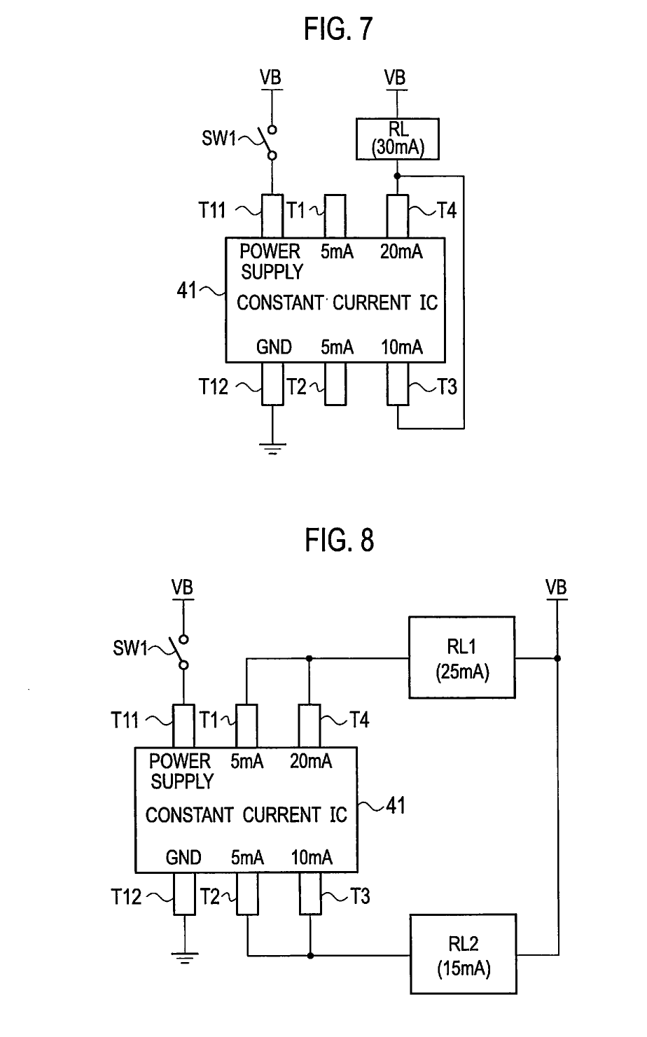

As illustrated in FIG. 6, when the value of the current to be supplied to a load RL is 5 mA, the load RL may be connected to the connection terminal T1 (5 mA). As illustrated in FIG. 7, when the value of the current to be supplied to the load RL is 30 mA, the load RL may be connected to both the connection terminals T3 (10 mA) and T4 (20 mA).

As illustrated in FIG. 8, it is also possible to set the value of the current to be supplied to the load RL1 to 25 mA by connecting the load RL1 to both the connection terminals T1 and T4, and at the same time to set the value of the current to be supplied to a load RL2 to 15 mA by connecting the load RL2 to both the connection terminals T2 and T3. That is, with one constant current circuit, two currents can be generated and supplied to the loads RL1 and RL2, respectively.

In the output setting device of the constant current circuit according to the present modified example, by connecting one or more connection terminals T1 to T4 to a load, it is possible to make setting so as to feed a desired current through the load. Moreover, a desired current can be supplied to each of the loads RL1 and RL2, and the versatility in setting the current value can be improved.

In the foregoing, the output setting device of the constant current circuit of the present invention has been described based on the illustrated embodiment, but the present invention is not limited thereto. The configuration of each unit can be replaced with any configuration having a similar function.

For example, in the embodiment described above, an example has been described in which the current mirror circuit groups 21 to 24 feed the currents which have values respectively generated by multiplying the reference current by α to 8α, by connecting a plurality of transistors in parallel, but the current mirror circuit groups 21 to can be also formed by one transistor which has characteristics of feeding the current which has a value generated by multiplying the reference current by α. That is, the transistors Q1 to Qm illustrated in FIG. 3 can be also formed by one transistor.

In the embodiment described above, an example using a bipolar transistor as the transistor constituting the current mirror circuit has been described, but other transistors such as an MOSFET can be also used. Moreover, in the embodiment described above, an example of providing four current mirror circuit groups 21 to 24 has been described, but the present invention is not limited thereto. It is also possible to provide two, three, or five or more current mirror circuit groups.

In the embodiment described above, an example has been described in which the current mirror circuit groups 21 to 24 output currents different from each other, but it is also possible for all the current mirror circuit groups 21 to 24 to feed an identical current.

In the embodiment described above, an example has been described in which the emitters of the current mirror circuit groups 21 to 24 are connected to the ground and the collectors thereof are connected to a load, but the load may be provided between the emitters and the ground.

The present invention is extremely useful in setting a desired current value with a simple operation and supplying the current to a load.

What is claimed is :

1. An output setting device of a constant current circuit that sets a current to be supplied to a load, the output setting device comprising:
a reference current generator that feeds a reference current;
a plurality of current mirror circuit groups each having at least one current mirror circuit that feeds a current proportional to the reference current;
a power supply terminal;
a ground terminal; and
a plurality of connection terminals,
wherein the reference current circuit has one end connected to the power supply terminal and the other end connected to the ground terminal,
wherein each current mirror circuit group has a first major electrode and a second major electrode,
wherein the first major electrode is connected to one of the plurality of connection terminals, and the second major electrode is connected to the ground terminal,
wherein a connection terminal of one current mirror circuit group or connection terminals of two or more current mirror circuit groups connected in parallel to each other among the plurality of current mirror circuit groups are connected to the load to set a current to be supplied to the load.

2. The output setting device of the constant current circuit according to claim 1, wherein the plurality of current mirror circuit groups outputs current values different from each other.

3. The output setting device of the constant current circuit according to claim 2, wherein the number of the current mirror circuit groups is k (“k” is a positive integer), and when the reference current is set to Iref, the i-th current mirror circuit group (“i” is a positive integer equal to or less than k) outputs a current value of 2⁽ⁱ⁻¹⁾·α·Iref.
